(19) United States
(12) Patent Application Publication
(10) Pub. No.: US 2004/0112491 A1
(43) Pub. Date: Jun. 17, 2004

(54) Tire and support

(76) Inventor: Michael D. Grah, Simpsonville, SC (US)

Correspondence Address: Michelin North America, Inc., Intellectual Property Department, P.O. Box 2026, Greenville, SC, 29602-2026, US

(21) Appl. No.: 10/721,152

(22) Filed: Nov. 25, 2003

Related U.S. Application Data
(63) Continuation of application No. PCT/US02/17173, filed on May 29, 2002.

(51) Int. Cl. B60C 17/04; B60C 17/06

(52) U.S. Cl. 152/158; 152/520

(57) ABSTRACT

A support according to the invention comprises a rubber article. The support comprises:

a substantially cylindrical base which conforms to the wheel rim,

a substantially cylindrical crown which comes into contact with the inside of the tire summit in the event of a drop in inflation pressure, but to leave a clearance relative to the summit at nominal inflation pressure, and

an annular body connecting the base to the crown. The rubber article comprises a rubber, preferably a mix of natural rubber and polybutadiene, a metal salt of a carboxylic acid, preferably zinc dimethacrylate, an effective amount of carbon black or silica, or both, and a peroxide for curing of said support. The support of the present invention provides weight reduction, reduced hysteresis, enhanced thermal stability, and enhanced thermo-oxidative stability, therefore providing longer service life.

### FIELD OF THE INVENTION

The present invention is in the field of tires, and more specifically, in the field of pneumatic tires that function with or without inflation pressure.

### BACKGROUND OF THE INVENTION

There is an ongoing effort by automobile manufacturers to eliminate the spare tire in order to reduce vehicle curb weight, increase available space within the vehicle, and provide operator convenience. This is particularly true for vehicles having higher comfort specifications, such as conventional luxury, family or urban-economy-type vehicles. This is even true for the sports utility vehicle, and for the new generation of electrical and hybrid-type vehicles which have critical space and weight restrictions.

Furthermore, with increased travel on multi-lane high-speed highways, even if a vehicle with a flat can be maneuvered to the roadside, changing a flat can be hazardous. Thus, the capability to readily reach the next exit is highly desirable should a flat occur.

One partial solution is the recently introduced “runflat” tire. This is a pneumatic tire that functions for a certain period to support a vehicle even after inflation pressure has been lost. This tire reduces the need for a spare tire and ancillary equipment. Therefore, in some cases it may achieve substantial savings in vehicle weight, and increase the space for other automotive systems and cargo. Numerous variations of runflat tires have been developed. However, the thickened sidewall of the runflat tire may detract from the normal handling and ride comfort characteristics of the tire, as well as generate significant heat when the tire is in the uninflated condition.

Another effort has been the use of a combined tire, wheel and support assembly. U.S. Pat. Nos. 5,891,279; 5,749,982 and 5,634,993, all assigned to Compagnie Generale Des Etablissements Michelin-Michelin & Cie (France), disclose such an assembly.

Japanese patent specification JP-A-3/82601 discloses a support comprising a substantially ,cylindrical base and crown, which further comprises an annular body connecting the base and crown.

U.S. Pat. No. 4,248,286, assigned to the Goodyear Tire & Rubber Co. discloses a support mounted on a rim inside a tire chamber to support the tread portion of the tire in the deflated condition.

However, the above-described supports may generate significant heat when the tire is uninflated. Therefore, there is a need for an improved support for a tire and wheel assembly that can provide enhanced durability when the tire is in the uninflated condition.

### SUMMARY OF THE INVENTION

A support according to the invention comprises a rubber article. The support comprises:

a substantially cylindrical base which conforms to the wheel rim,

a substantially cylindrical crown which comes into contact with the inside of the tire summit in the event of a drop in inflation pressure, but to leave a clearance relative to the summit at nominal inflation pressure, and

an annular body connecting the base to the crown. The article comprises a rubber, preferably a mix of natural rubber and polybutadiene, a metal salt of a carboxylic acid, preferably zinc dimethacrylate, an effective amount of a filler, preferably carbon black or silica, or both, and a peroxide for curing of said support. The support of the present invention provides weight reduction, reduced hysteresis, enhanced thermal stability, and enhanced thermo-oxidative stability, therefore providing longer service life.

Therefore it is an object of the present invention to provide an improved support for an uninflated tire that generates a minimum of heat while providing adequate handling characteristics.

Therefore it is an object of the present invention to provide an improved support which is as lightweight as possible, while maintaining adequate strength to provide good handling for a vehicle with an uninflated tire.

### BRIEF DESCRIPTION OF THE DRAWINGS

FIG. 1 is a side view of a support according to one embodiment of the invention;

FIG. 2 is an axial section of a mounted assembly according to the invention, in which the support of FIG. 1 is mounted on a wheel rim and is in supporting position against the inside summit of a tire.

### DETAILED DESCRIPTION OF THE INVENTION

A support according to the invention comprises a rubber article. The support comprises:

a substantially cylindrical base which conforms to the wheel rim,

a substantially cylindrical crown which comes into contact with the inside of the tire summit in the event of a drop in inflation pressure, but to leave a clearance relative to the summit at nominal inflation pressure, and

an annular body connecting the base to the crown. The article comprises a rubber, preferably a mix of natural rubber and polybutadiene, a metal salt of a carboxylic acid, preferably zinc dimethacrylate, an effective amount of a filler, preferably carbon black or silica, or both, and a peroxide for curing of said support. The support of the present invention provides weight reduction, reduced hysteresis, enhanced thermal stability, and enhanced thermo-oxidative stability, therefore providing longer service life.

The elements of the invention are described in greater detail below. All patents and publications are expressly incorporated by reference.

### The Mechanical Structure of the Support

A mounted assembly for a motor vehicle comprises a wheel rim, a tire mounted on the rim and the support according to the invention. The rim comprises on each of the peripheral edges thereof a rim seat intended to receive a bead of the tire, the rim therefore having two seats. The rim comprises between the two seats, a bearing surface and a mounting groove connecting the bearing surface to an axially internal lip of one of the seats, or first seat.

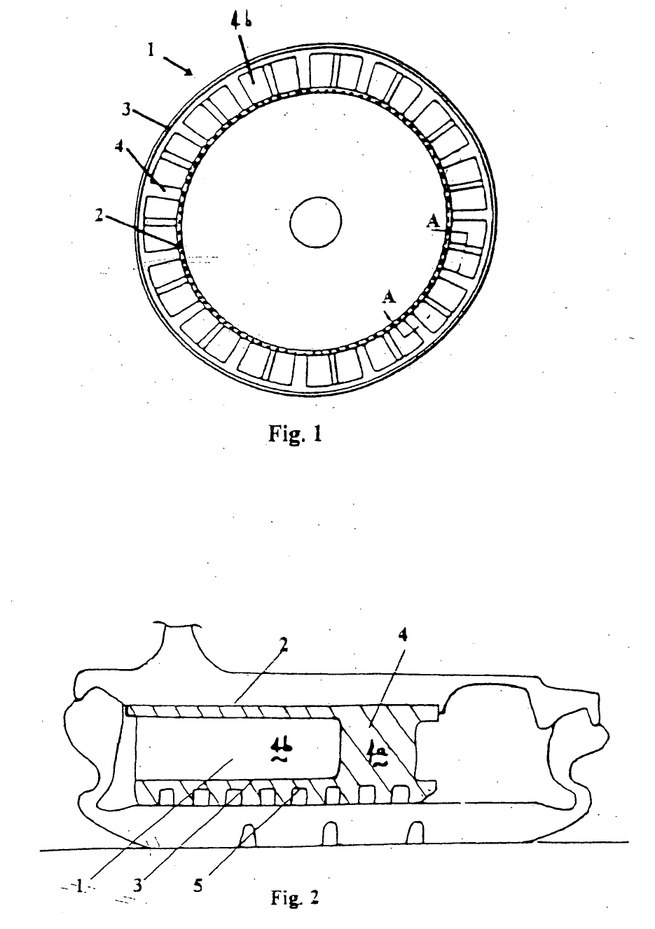

In two embodiments of the invention, shown in FIGS. 1 and 2, each of supports 1 essentially have three parts:

a base 2, of generally annular shape;

a substantially annular crown 3, optionally having longitudinal grooves 5 on the radially external wall thereof, and

an annular body 4 connecting base 2 and crown 3.

FIG. 2 illustrates the function of support 1, namely supporting the tire tread in the event of severe loss of inflation pressure of the tire. The section of FIG. 2 shows a first solid portion 4a of annular body 4 together with a second portion 4b having recesses.

One rim usable for this mounted assembly is shown in FIG. 2 (This rim is also described in detail in French patent specification FR-A-2 720 977.)

FIGS. 1 and 2 show a first annulus with a substantially rectangular axial section, and one or more annular elements comprising a plurality of recesses and extending substantially axially across the entire width thereof and distributed substantially, regularly around the circumference thereof. Such a ring-type support is easier to introduce into a tire, due to the lower flexural rigidity of the various annular elements thereof.

Other embodiments of the support are possible. For example, the support might have two or more rings connected together in the axial direction of the support.

### Rubber Compositions Useable in the Support

The rubber employed may be a dienic unsaturated elastomer. This type of rubber includes natural rubber, polyisoprene, polybutadiene, and styrene-butadiene rubber. Also useful for the present invention are copolymers of butyl acrylonitrile, and copolymers of butyl paramethyl styrene. These rubbers are curable with a metal salt of a carboxylic acid and a peroxide cure system. Blends of such rubbers may also be employed. [see, e.g., Sartomer Co., Inc., “Sartomer Application Bulletin: Basic Principles of Peroxide-Coagent Curing of Elastomers,” April 1997, incorporated by reference.]

Preferred rubbers include natural rubber and polybutadiene. As used herein, “rubber” and “elastomer” are synonymous.

### Metal Salts of Carboxylic Acids Useable in the Support

The support comprises certain polymerizable metal salts of alpha, beta-ethylenically unsaturated carboxylic acids. Preferred metal salts of carboxylic acid are metal salts of di- and tri-acrylic acid and methacrylic acid. Suitable zinc salts of di- and tri-acrylic acid and methacrylic acid are described in Sartomer Co., Inc., “New Metallic Coagents for Curing Elastomers”, April 1998. Other suitable acrylates are disclosed in Sartomer Co., Inc., Sartomer Application Bulletin, May 1998, “Chemical Intermediates—Design Unique Polymers with Sartomer's Specialty Monomers,” and Sartomer Co., Inc., Sartomer Application Bulletin, October 1999, “Glass Transition Temperatures of Sartomer Products.” Both publications are incorporated by reference. A particularly preferred monomer for this use is zinc dimethacrylate, which may also be referred to as a metal acrylate. In one embodiment of the invention, the metal salt of the carboxylic acid is present in an amount from 5 to 70 parts per hundred parts by weight of rubber. In a more preferred embodiment of the invention, the metal salt is present in an amount from 10 to 60 parts per hundred parts by weight of rubber. In a most preferred embodiment of the invention, the metal salt is present in an amount from 20 to 50 parts per hundred parts by weight of rubber.

In the present invention zinc dimethacrylate or other metal salt of a carboxylic acid is combined with at least one of the rubber polymers disclosed above.

Zinc dimethacrylate may be prepared by reacting with agitation zinc oxide and methacrylic acid in an amount of from about 0.5 to about 0.6 moles of zinc oxide per mole of methacrylic acid in a liquid medium (e.g., water or a volatile organic liquid such as a liquid hydrocarbon).

### Peroxide Curing Agents Useable in the Support

Peroxides, which may be employed to catalyze the curing of the elastomer of the support ring, include, but are not limited to: di-cumyl peroxide, bis-(tert-butyl peroxy)-diisopropyl benzene, t-butyl perbenzoate, di-tert-butyl peroxide, 2,5-dimethyl-2,5-di-tert-butyl peroxide hexane, etc. About 0.5to 5 parts per one-hundred parts by weight of rubber has been found effective. However, amounts of peroxide curing agents included in the composition will depend upon the elastomer and coagent loading utilized.

### Fillers Useable in the Support

Suitable fillers include carbon black, silica, aluminas, aluminum hydroxide, aluminum silicate (“white fillers”), clays, calcium carbonate, glass fibers, microspheres, polymeric fibers such as polyester, nylon, or aramid fibers. The appropriate level of filler would be known to one of skill in the art after reading the present specification. In one embodiment of the invention, the filler is present in an amount from 0 to 120 parts per hundred parts by weight of elastomer, more preferably 0 to 60 parts per hundred parts by weight of elastomer.

In another embodiment of the invention, the rubber may contain from 0 to 2.5 parts parts by weight of sulfur per hundred parts by weight of rubber.

### Other Materials Useable in the Support

The rubber compositions according to the invention may also contain, in addition to the elastomer(s), reinforcing filler, sulphur and one or more reinforcing white filler/elastomer bonding agent(s), various other constituents and additives usually used in rubber mixtures, such as plasticizers, pigments, antioxidants, vulcanization accelerators, extender oils, processing aids, and one or more agents for coating the reinforcing white filler, such as alkoxysilanes, polyols, amines etc.

In one embodiment of the invention, the rubber composition is composed of the following:

Polybutadiene 0 to 80% by weight

Natural rubber 20 to 100% by weight

Silica and carbon black 5 to 120 parts by weight per hundred weight of rubber (in any ratio)

Zinc dimethacrylate 5 to 70 parts by weight per hundred weight of rubber

### Properties of the Rubber Article of the Present Invention

Rubber compositions formed with metal salts of carboxylic acids generate less hysteresis than would a conventional filled rubber composition, and so have lower operating temperatures. This reduction in temperature improves the endurance of the support ring under runflat conditions. The reduced hysteresis of this composition is particularly apparent at lower temperatures. When the support system of the present invention transitions from regular pneumatic to nonpneumatic operation, the support ring formulated with the zinc dimethacrylate (ZDMA) composition will heat up more slowly than a support made from a conventional carbon black or silica-reinforced rubber at the same stiffness-Level.

According to one embodiment of the present invention the support ring is constructed to operate at a defined level of compressive strain (10%-15%) at the requited loading.

A further advantage of application of the present invention is improved thermo-oxidative stability. Under normally inflated operating conditions, the internal temperature of the support system approximates the temperature of the tire, about 40° C. This temperature can be as high as 65° C. Under normal inflation pressure (2.5 bar), the partial pressure of oxygen in the tire chamber is 0.52 bar. Under runflat conditions, the support ring can heat up to temperatures greater than 100° C. Therefore, in both the pneumatic and the runflat mode, the support ring is subject to harsh oxidizing conditions. A support ring constructed from rubber vulcanized with a sulfur-sulfur accelerator based system would break down more rapidly under such conditions. The ZDMA/peroxide compositions have bond stabilities that are 20% to 130% higher than those of conventional rubber. This increased bond stability results directly in greatly improved thermo-oxidative stability under both inflated and in the runflat mode.

Zinc dimethacrylate rubber compositions are also lighter than conventional rubber compositions. For example, ZDMA-based compositions are found to be approximately 7% less dense than conventional silica-filled compositions (due to replacement of carbon black (density=1.8 g/cm³) and silica (density=2.0 g/cm³) with ZDMA (density=1.5 g/cm³). Further, these compositions exhibit higher modulus in the operating range of the support ring that allows additional mass reductions, since less material is needed to support the required load.

Therefore, one embodiment of the present invention is a support for mounting on a wheel rim inside a vehicle tire, where the support is capable of supporting a tire in the event of a drop in inflation pressure. The support is a rubber article having a composition comprising a metal salt of a carboxylic acid. Another embodiment of the invention is a wheel comprising the support.

The support of the present invention shows good cohesion (i.e., greater resistance to initiation of tears and propagation of tears) of the support. This is important when a vehicle is turning, or when the vehicle rides over a sudden depression in the road, briefly subjecting the support to a high level of deformation.

The present invention is a support for mounting on a wheel rim inside a vehicle tire, the support being capable of supporting a tire in the event of a drop in inflation pressure. The support is an article having a composition, comprising rubber and a metal salt of a carboxylic acid, where the composition is cured with a peroxide curing agent. The present invention is also a wheel comprising the support.

The rubber may be a dienic unsaturated elastomer. In one embodiment of the invention, the rubber includes copolymers of butyl acrylonitrile and copolymers of butyl paramethyl styrene, or mixtures thereof. In one embodiment of the invention, the support is composed of rubber is selected from the group consisting of natural rubber, polyisoprene, polybutadiene, styrene-butadiene rubber, and mixtures thereof. The metal salt may be selected from the group consisting of di- and tri-acrylates and methacrylates and mixtures thereof. Preferably, the metal salt of the carboxylic acid is zinc dimethacrylate.

The peroxide is selected from the group consisting of di-cumyl peroxide, bis-(tert-butyl peroxy)-diisopropyl benzene, t-butyl perbenzoate, di-tert-butyl peroxide, 2,5-dimethyl-2,5-di-tert-butylperoxide hexane and mixtures thereof. The composition may include a filler, which may be selected from carbon black, silica, aluminas, aluminum hydroxide, aluminum silicate, clays, calcium carbonate, glass fibers, microspheres, polymeric fibers, and mixtures thereof. In one embodiment, the filler is present in an amount from 0 to 120 parts per hundred parts by weight of elastomer. In another embodiment of the invention, the filler is present in an amount from 0 to 60 parts per hundred parts by weight of elastomer. In another embodiment of the invention, the composition includes sulfur, in an amount from 0 to 2.5 parts per hundred parts by weight of rubber.

In another embodiment of the invention, the support comprises:

(a) a substantially cylindrical base, intended to conform to the wheel rim,

(b) a substantially cylindrical crown intended to contact the tire tread in the event of a drop in inflation pressure and to leave a clearance relative to the tread at nominal pressure, and

(c) an annular body connecting the base to the crown, the annular body comprising a circumferentially continuous supporting element with a circumferential median plane, wherein the supporting element comprises:

(i) a plurality of partitions extending axially on each side of the circumferential median plane and distributed around the circumference of the support, and

(ii) joining elements extending substantially circumferentially on one of the sides of the support, each joining element connecting the respective ends of two adjacent partitions which are arranged on the side of the support, the joining elements being arranged alternately in succession on each side of the partitions, wherein, between two adjacent partitions, the joining elements are mutually supported by a rib extending from the crown to the base of the support, such that the joining elements form a continuous joining wall in the form of a gusset extending along the side of the support.

Another embodiment of the invention is a support intended to be mounted on a wheel rim inside a tire equipping a vehicle, in order to support the tread strip of the tire in the event of a loss of inflation pressure. The support is comprised of a rubber composition comprising a metal salt of a carboxylic acid, and it includes: a substantially cylindrical base intended to fit around the wheel rim, a substantially cylindrical cap intended to come into contact with the tread strip in the event of a loss of pressure, and leaving a clearance with respect hereto at nominal pressure, and an annular body connecting said base and said cap. The body has a plurality of cavities directed substantially axially and emerging in that face of the body which is intended to be placed on the outboard side of the vehicle, and which extend axially as far as at least halfway into the body without passing through it.

The support may comprise 5 to 70 parts by weight of metal salt of a carboxylic acid per hundred parts by weight of rubber. More preferably, it comprises 10 to 60 parts by weight of metal salt of a carboxylic acid per hundred parts by weight of rubber. Most preferably, the support comprises 20 to 50 parts by weight of metal salt of a carboxylic acid per hundred parts by weight of rubber. In one embodiment of the invention, the support comprises 20 to 120 parts by weight of a mixture of silica and carbon black, in any ratio, per hundred parts by weight of rubber.

In one embodiment of the invention, the support comprises 0 to 80% by weight of polybutadiene. In another embodiment of the invention, the support comprises 20 to 100% by weight of natural rubber.

The advantages of the improved support of the present invention will become more apparent upon inspection of the following non-limiting examples.

### EXAMPLE 1

### ZDMA Mixes Compared to Control Mix

TABLE 1
Composition of Rubber Mixes used in the support ring

| | Control | 1 | 2 | 3 | 4 | 5 | 6 |
|---|---|---|---|---|---|---|---|
| Natural Rubber | 100 | 35 | 35 | 35 | 35 | 35 | 35 |
| Polybutadiene Rubber | | 65 | 65 | 65 | 65 | 65 | 65 |
| (1) | | | | | | | |
| Precipitated Silica | 62 | | | | | | |
| (Zeosil 160MP) | | | | | | | |
| N650 Carbon Black | | 50 | 40 | 40 | 20 | 20 | |
| Zinc Dimethacrylate (2) | | 15 | 25 | | 45 | | 65 |
| Zinc Diacrylate (3) | | | | 25 | | 45 | |
| Santoflex 13 | 2 | | | | | | |
| X50S (4) | 9.9 | | | | | | |
| Zinc Oxide | 4 | | | | | | |
| Stearic Acid | 1 | | | | | | |
| Sulfur | 4.5 | | | | | | |
| Cyclohexylbenzothiazyl | 3 | | | | | | |
| Sulfenamide (5) | | | | | | | |
| Dicumyl Peroxide (6) | | 5 | 5 | 5 | 5 | 5 | 5 |

(1) PB1208, Goodyear Chemical Corp ., Akron, Ohio 44304

(2) SR634, Sartomer Corp., Exton, Pa. 19341

(3) SR633, Sartomer Corp.

(5) Santocure CBS (N-cyclohexylbenzothiazyl sulphenamide), Flexsys America (Akron, Ohio,44334)

(6) Dicup 40C (dicumyl peroxide), Hercules Corp., Wilmington, Del. 19894

(8) 50% Si69 on carbon black carrier

(9) Santoflex 13 (N-(1,3-Dimethylbutyl)-N′-phenyl-p-phenylenediamine) (Flexsys Rubber Chemicals Ltd., Netherlands)

[N650 carbon black is available from Engineered Carbons, Inc., Borger, Tex. 79008, and other suppliers]

[6PPD is N-(1,3-dimethylbutyl)-N′-phenyl-p-phenyleniediamine.]

[TMQ is poly(1,2-dihydro-2,2,4-trimethyl quinoline. It is also known as Vulcanox 4020, by Bayer]

[Si69 is bis(3-triethoxysilylpropyl) tetrasulphide having the formula [(C₂H₅O)₃Si(CH₂)₃S₂]₂ by Degussa Corp. (Ridgefield Park, N.J.) under the name Si69(or X50S when supported at a content of 50 percent by weight on carbon black)]

[Zeosil 160MP available from Rhone-Poulenc]

TABLE 2
Properties of Rubber Mixes used in the support ring

Static Properties

| | | | | | | | |
|---|---|---|---|---|---|---|---|
| Mooney Viscosity (ML 1 + 4) | 83 | 76 | 69 | 32 | 56 | 17 | 41 |
| 100° C. | | | | | | | |
| Modulus at 10% Strain | 12 | 17 | 24 | 16 | 44 | 20 | 55 |
| @ 23° C. (MPa) | | | | | | | |
| DYNAMIC PROPERTIES | | | | | | | |
| G′ @ 40° C., 10% shear strain | 4.7 | 5.0 | 7.3 | 5.2 | 13.3 | | 14.0 |
| (MPa) | | | | | | | |
| Tan δ @ 40° C., 10% shear | 0.16 | 0.05 | 0.045 | 0.07 | 0.041 | | 0.043 |
| strain | | | | | | | |
| G′ @ 100° C., 10% shear | 4.8 | 4.9 | 7.2 | 3.8 | 11.8 | | 13.9 |
| strain (MPa) | | | | | | | |
| Tan δ @ 100° C., 10% shear | 0.079 | 0.041 | 0.042 | 0.040 | 0.044 | | 0.045 |
| strain | | | | | | | |
| Rubber Density (g/cm³) | 1.20 | 1.13 | 1.12 | 1.06 | 1.11 | | 1.09 |

Dynamic properties were measured on an MTS loading rig (MTS Systems Corp., Eden Prairie, Minn. 55344) at 10 hertz under pure shear mode of deformation.

Under tensile loading, the force divided by the original area of the sample under duress is called the stress (shown above in units of mega Pascals). The displacement (movement or stretch) of the material is called the strain. Normally the strain is given as the change in length divided by the original length, and the units are dimensionless. The modulus is the slope of the curve of stress versus strain (stress in the ordinate, strain in the abscissa) The elastic shear modulus (G′) of a material is the ratio of the elastic (in-phase) stress to strain and relates to the ability of a material to store energy elastically. The loss modulus (G″) of a material is the ratio of the viscous (out of phase) component to the shear strain, and is related to the material's ability to dissipate stress through heat. The ratio of these moduli (G′/G″) is defined as tangent delta, and indicates the relative degree of viscous to elastic dissipation, or damping of the material. A low tan delta means higher resilience and less hysteresis.

In Table 2, G′ represents the shear modulus in mega Pascals, and tan delta represents the relative hysteresis of the material.

Control #1 has a composition using precipitated silica as the reinforcing agent. The control is crosslinked with a sulfur/accelerator combination. The modulus of the control is ultimately limited by the maximum amount of filler that can be adequately dispersed in the elastomer and by the need to maintain acceptable viscosity for processing. This data demonstrates that the support compositions containing metal salt acrylates are capable of achieving higher modulus values than the already excellent conventional materials while maintaining good processibility. In addition, they may have an improved compromise between modulus and hysteresis when operating in the ‘initial’ stage of the runflat condition (10% strain and 40° C.) as well as in later stages of the runflat mode (10% strain and 100° C.). This data suggests that at an equal load capacity, a support ring made from ZDMA-based compositions will be thinner and lighter than a support made from the control composition, resulting in reduced mass. Further, under runflat conditions, the ZDMA-filled mixes generate less heat at equivalent deflection levels, so the support might run cooler and perhaps last longer than a support made with the excellent control materials.

Example #2, Comparison of thermo-oxidative aging properties of support ring materials. Two compositions were evaluated for their succeptibility to thermo-oxidative degradation. A standard silica-reinforced and sulfur-cured rubber mix was chosen as the control, and a ZDMA-filled mix was compounded to provide a similar level of unaged modulus at 10% strain. The compositions are shown in Table 3. Both compounds were aged for various times in air at 77° C. Properties were measured after successive aging times and reported in Table 4. This data demonstrates that even though the control mix had a potent combination of antioxidants compared to the ZDMA-filled mix, it was observed to age-harden at a faster rate. While the control mix possessed a higher level of elasticity initially, after heat aging for 28 days, the ZDMA-filled mix was found to retain three times more elasticity than the control. For the ZDMA-filled mix, the modulus stayed approximately the same through the 28-day period. However the modulus more than doubled in the conventional mix. For the ZDMA mix, the ultimate rupture stress decreased only slightly, and the ultimate rupture strain decreased about twenty percent. However, for the control, the ultimate rupture stress decreased over thirty percent, and the ultimate rupture strain decreased over seventy-five percent.

The data show that the ZDMA mix preserves its elasticity, so might have improved resistance to thermo-mechanical -failure, thermo-oxidative degradation, and failure from instaneous spike deformations (i.e., shocks from potholes in the road) than the already excellent conventional rubber mix.

TABLE 3
Composition of the Rubber Samples used in the Aging Study

| | | ZDMA |
|---|---|---|
| | Control 1 | mix |
| Natural Rubber | 100 | 80 |
| Polybutadiene Rubber (1) | | 20 |
| Precipitated Silica RP160 II | 62 | |
| N650 Carbon Black | | 30 |
| Zinc Dimethacrylate (2) | | 30 |
| Zinc Diacrylate (3) | | |
| Santoflex 13 | 2 | |
| TMQ | | 1 |
| X50S (8) | 9.9 | |
| Zinc Oxide | 4 | 4 |
| Zinc Stearate | | 4 |
| Stearic Acid | 1 | 1 |
| Sulfur | 4.5 | |
| Cyclohexylbenzothiazyl Sulfenamide | 3 | |
| (5) | | |
| Dicumyl Peroxide (6) | | 5 |

TABLE 4
Properties of Rubber Samples Aged at 77° C. in Air

| Properties | Control 1 | ZDMA mix |
|---|---|---|
| Modulus at 10% Strain @ 23° C. (MPa) | | |
| Unaged | 10.3 | 12.3 |
| 7 days | 14.7 | 12.8 |
| 14 days | 15.0 | 12.6 |
| 28 days | 20.5 | 12.0 |
| Modulus at 100% Strain @ 23° C. (MPa) | | |
| Unaged | 4.2 | 6.2 |
| 7 days | 6.8 | 6.6 |
| 14 days | 6.0 | 6.6 |
| 28 days | 10.2 | 6.3 |
| Ultimate Rupture Stress @ 100° C. (MPa) | | |
| Unaged | 13.0 | 12.1 |
| 7 days | 10.8 | 12.2 |
| 14 days | 14.7 | 13.0 |
| 28 days | 8.6 | 11.5 |
| Ultimate Rupture Strain @ 100° C. (MPa) | | |
| Unaged | 223 | 187 |
| 7 days | 106 | 166 |
| 14 days | 168 | 174 |
| 28 days | 51 | 147 |

After reading the foregoing specification it will be apparent to one of skill in the art that various modifications of the foregoing invention are possible. These modifications are meant to fall within the scope of the appended claims.

I claim:

1. A support for mounting on a wheel rim inside a vehicle tire, the support being capable of supporting a tire in the event of a drop in inflation pressure, wherein the support is an article having a composition comprising rubber and a metal salt of a carboxylic acid, wherein the composition is cured with a peroxide curing agent.

2. A wheel comprising the support of claim 1.

3. The support of claim 1, wherein the rubber is comprised of a dienic unsaturated elastomer.

4. The support of claim 1, wherein the rubber is comprised of a rubber selected from the group consisting of copolymers of butyl acrylonitrile and copolymers of butyl paramethyl styrene.

5. The support of claim 1 wherein the rubber is selected from the group consisting of natural rubber, polyisoprene, polybutadiene, styrene-butadiene rubber, and mixtures thereof.

6. The support of claim 1, wherein the metal salts is selected from the group consisting of di- and tri-acrylates and methacrylates and mixtures thereof.

7. The support of claim 1, wherein the metal salt of the carboxylic acid is zinc dimethacrylate.

8. The support of claim 1, wherein the peroxide is selected from the group consisting of di-cumyl peroxide, bis-(tert-butyl peroxy)-diisopropyl benzene, t-butyl perbenzoate, di-tert-butyl peroxide, 2,5-dimethyl-2,5-di-tert-butylperoxide hexane and mixtures thereof.

9. The support of claim 1, further comprising wherein the composition includes a filler, and the filler is selected from the group consisting of carbon black, silica, aluminas, aluminum hydroxide, aluminum silicate, clays, calcium carbonate, glass fibers, microspheres, polymeric fibers, and mixtures thereof.

10. The support of claim 9, wherein the filler is present in an amount from 0 to 120 parts per hundred parts by weight of elastomer.

11. The support of claim 9, wherein the filler is present in an amount from 0 to 60 parts per hundred parts by weight of elastomer.

12. The support of claim 1, further comprising sulfur in an amount from 0 to 2.5 parts per hundred parts by weight of rubber.

13. The support of claim 1, wherein the support comprises:
(a) a substantially cylindrical base, intended to conform to the wheel rim,
(b) a substantially cylindrical crown intended to contact the tire tread in the event of a drop in inflation pressure and to leave a clearance relative to the tread at nominal pressure, and
(c) an annular body connecting the base to the crown, the annular body comprising a circumferentially continuous supporting element with a circumferential median plane, wherein the supporting element comprises:
(i) a plurality of partitions extending axially on each side of the circumferential median plane and distributed around the circumference of the support, and
(ii) joining elements extending substantially circumferentially on one of the sides of the support, each joining element connecting the respective ends of two adjacent partitions which are arranged on the side of the support, the joining elements being arranged alternately in succession on each side of the partitions, wherein, between two adjacent partitions, the joining elements are mutually supported by a rib extending from the crown to the base of the support, such that the joining elements form a continuous joining wall in the form of a gusset extending along the side of the support.

14. A support intended to be mounted on a wheel rim inside a tire equipping a vehicle, in order to support the tread strip of the tire in the event of a loss of inflation pressure, said support being characterized in that it is comprised of a rubber composition comprising a metal salt of a carboxylic acid, and in that it includes: a substantially cylindrical base intended to fit around the wheel rim, a substantially cylindrical cap intended to come into contact with the tread strip in the event of a loss of pressure, and leaving a clearance with respect hereto at nominal pressure, and an annular body connecting said base and said cap, said body having a plurality of cavities directed substantially axially and emerging in that face of said body which is intended to be placed on the outboard side of the vehicle
and which extend axially as far as at least halfway into said body without passing through it.

15. The support of claim 1 comprising 5 to 70 parts of metal salt of a carboxylic acid per hundred parts by weight of rubber.

16. The support of claim 1 comprising 10 to 60 parts of metal salt of a carboxylic acid per hundred parts by weight of rubber.

17. The support of claim 1 comprising 20 to 50 parts of metal salt of a carboxylic acid per hundred parts by weight of rubber.

18. The support of claim 9 comprising 20 to 120 parts of a mixture of silica and carbon black, in any ratio, per hundred parts by weight of rubber.

19. The support of claim 1 comprising 0 to 80% by weight of polybutadiene.

20. The support of claim 1 comprising 20 to 100% by weight of natural rubber.
